(19) United States
(12) Patent Application Publication
(10) Pub. No.: US 2007/0076712 A1
(43) Pub. Date: Apr. 5, 2007

(54) Processing packet headers

(76) Inventors: Steve Leslie Pope, Cambridge (GB); Derek Edwards Roberts, Cambridge (GB); David James Riddoch, Cambridge (GB)

Correspondence Address: WEIDE & MILLER, LTD., 7251 W. LAKE MEAD BLVD., SUITE 530, LAS VEGAS, NV, 89128, US

(21) Appl. No.: 11/584,306

(22) Filed: Oct. 19, 2006

(30) Foreign Application Priority Data
Apr. 21, 2004 (WO) PCT/GB05/01349

(51) Int. Cl. H04L 12/56

(52) U.S. Cl. 370/389

(57) ABSTRACT

A network interface device interfaces between a host device and a network by receiving packets over the network and passing at least some of those packets to ports of the host device is disclosed. Each packet may comprise a control section having one or more fields indicative of the type and data protocol of the packet, a source address field indicative of the source address of the packet, a destination address field indicative of the destination address of the packet, a source port field indicative of the source address of the packet and a destination port field indicative of the destination address of the packet. The network device comprises a data store for storing specifications for packets that are to be passed to the host device. A packet selection unit is provided and is capable of identifying the protocol of a received packet and operable in a different modes.

### 1. PRIOR APPLICATION DATA

This application claims priority to PCT Application No. PCT/GB2005/001349, entitled Processing Packet Headers which was published as WO 2005/104453 and which is entitled to a priority date of Apr. 21, 2004.

### 2. FIELD OF THE INVENTION

This invention relates to a network interface and in particular to an interface device for linking a computer to a network.

### SUMMARY

In one embodiment a network interface device for providing an interface between a host device and a network is disclosed. In this embodiment the device receives packets over the network and passing at least some of those packets to ports of the host device such that each packet comprises a control section having one or more fields indicative of the type and data protocol of the packet. Also part of the packet is a source address field indicative of the source address of the packet, a destination address field indicative of the destination address of the packet, a source port field indicative of the source address of the packet and a destination port field indicative of the destination address of the packet. In this example embodiment, the network device comprises a data store for storing specifications for packets that are to be passed to the host device such that each specification comprising first, second and third check fields and, a packet selection unit for selecting in accordance with the content of the data store which packets received over the network are to be passed to the host device. In this configuration the packet selection unit is capable of identifying the protocol of a received packet and operable in at least the following modes. A first mode in which for packets of a first protocol and of a type indicative of a request to establish a new connection, such packets are passed to the host device only if the data store stores a specification whose first check field matches the destination address of the packet, and second check field matches a reserved datagram and a third check field matches the destination port of the packet. A second mode is provided in which for packets of a second protocol pass to the host device only if the data store stores a specification whose first check field matches the destination address of the packet, and the second check field matches the destination port of the packet and the third check field matches the reserved datagram.

It is further contemplated that the network interface device may be configured such that in the first mode the packet selection unit is operable to, for packets of the first protocol that are not indicative of a request to establish a new connection, pass such packets to the host device only if the data store stores a specification whose first check field matches the source address of the packet, and second check field matches the source port of the packet and the third check field matches the destination port of the packet. In addition, in one embodiment the packet selection unit is operable in a third mode in which for all packets of the first protocol such packets are passed to the host device only if the data store stores a specification whose first check field matches the source address of the packet, and the second check field matches the source port of the packet and the third check field matches the destination port of the packet.

Likewise, it is further contemplated that the packet selection unit is operable in a fourth mode in which for all packets of the first protocol pass to the host device only if the data store stores a specification whose first check field matches the destination address of the packet, and the second check field matches the reserved datagram and the third check field matches the destination port of the packet or if the data store stores a specification and the first check field matches the source address of the packet, and the second check field matches the source port of the packet and the third check field matches the destination port of the packet. In addition, the packet selection unit may be selectively operable in one of the first mode and whichever of the third and fourth modes it supports.

The packet selection unit may be operable in a fifth mode in which all packets of the second protocol pass to the host device only if the data store stores a first specification and the first check field matches the reserved datagram, one of whose second and third check fields matches the source address of the packet and the other of whose second and third check fields matches the source port of the packet and if the data store stores a second specification in a manner related by a predetermined relationship to the first specification whose first check field matches the reserved datagram, such that one of whose second and third check fields matches the source port of the packet and the said other of whose second and third check fields matches the destination port of the packet.

In one embodiment the network interface device is configured such that the predetermined relationship is that the second specification is stored in the data store at a predetermined spacing from the first specification. In addition, it is contemplated that the packet selection unit maybe selectively operable in one of the second and fifth modes. All of the bits of the predetermined datagram may be zero. The first protocol may comprise TCP protocol. As described herein the type indicative of a request to establish a new connection may comprise that for which the SYN bit equals 1 and the ACK bit equals 0. In one embodiment the length of the first check field is 32 bits and the length of the second check field may be 16 bits. In one embodiment the length of the third check field is 16 bits. The data store may be a content addressable memory. The width of the content addressable memory may be 64 bits.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views. The present invention will now be described by way of example with reference to the accompanying drawings, in which:

FIG. 1 is a schematic diagram of a network interface device in use;

FIG. 2 illustrates an implementation of a transport library architecture;

FIG. 3 shows an architecture employing a standard kernel TCP transport with a user level TCP transport;

FIG. 4 illustrates an architecture in which a standard kernel stack is implemented at user-level;

FIG. 5 shows an example of a TCP transport architecture;

FIG. 6 shows the steps that can be taken by the network interface device to filter an incoming TCP/packet; and

FIG. 7 illustrates to operation of a server (passive) connection by means of a content addressable memory.

### DETAILED DESCRIPTION

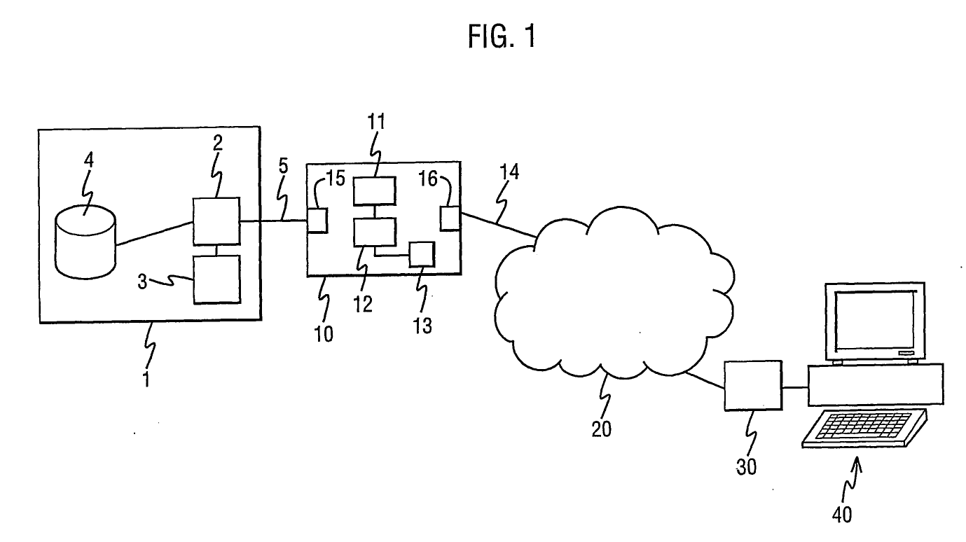

FIG. 1 is a schematic diagram showing a network interface device such as a network interface card (NIC) and the general architecture of the system in which it may be used. The network interface device 10 is connected via a data link 5 to a processing device such as computer 1, and via a data link 14 to a data network 20. Further network interface devices such as processing device 30 are also connected to the network, providing interfaces between the network and further processing devices such as processing device 40.

The computer 1 may, for example, be a personal computer, a server or a dedicated processing device such as a data logger or controller. In this example it comprises a processor 2, a program store 4 and a memory 3. The program store stores instructions defining an operating system and applications that can run on that operating system. The operating system provides means such as drivers and interface libraries by means of which applications can access peripheral hardware devices connected to the computer.

It is desirable for the network interface device to be capable of supporting standard transport protocols such as TCP, RDMA and ISCSI at user level: i.e. in such a way that they can be made accessible to an application program running on computer 1. Such support enables data transfers which require use of standard protocols to be made without requiring data to traverse the kernel stack. In the network interface device of this example standard transport protocols are implemented within transport libraries accessible to the operating system of the computer 1.

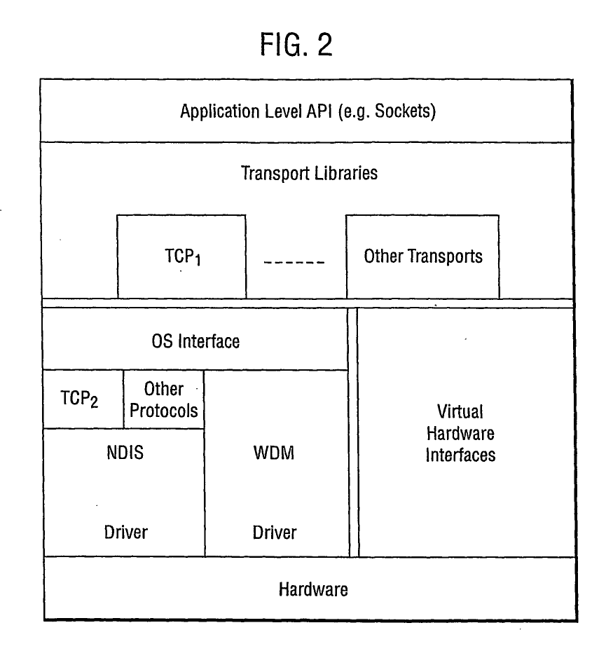

FIG. 2 illustrates one implementation of this. In this architecture the TCP (and other) protocols are implemented twice: as denoted TCP1 and TCP2 in FIG. 2. In a typical operating system TCP2 will be the standard implementation of the TCP protocol that is built into the operating system of the computer. In order to control and/or communicate with the network interface device an application running on the computer may issue API (application programming interface) calls. Some API calls may be handled by the transport libraries that have been provided to support the network interface device. API calls which cannot be serviced by the transport libraries that are available directly to the application can typically be passed on through the interface between the application and the operating system to be handled by the libraries that are available to the operating system. For implementation with many operating systems it is convenient for the transport libraries to use existing Ethernet/IP based control-plane structures: e.g. SNMP and ARP protocols via the OS interface.

There are a number of difficulties in implementing transport protocols at user level. Most implementations to date have been based on porting pre-existing kernel code bases to user level. Examples of these are Arsenic and Jet-stream. These have demonstrated the potential of user-level transports, but have not addressed a number of the problems required to achieve a complete, robust, high-performance commercially viable implementation.

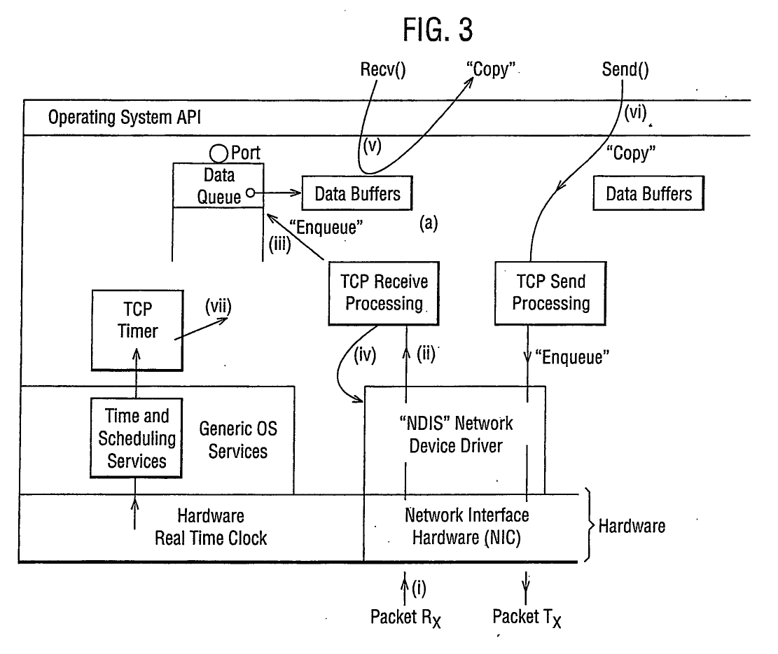

FIG. 3 shows an architecture employing a standard kernel TCP transport (TCPk).

The operation of this architecture is as follows. On packet reception from the network interface hardware (e.g. a network interface card (NIC)), the NIC transfers data into pre-allocated data buffer (a) and invokes the OS interrupt handler by means of the interrupt line. (Step i). The interrupt handler manages the hardware interface e.g. posts new receive buffers and passes the received (in this case Ethernet) packet looking for protocol information. If a packet is identified as destined for a valid protocol e.g. TCP/IP it is passed (not copied) to the appropriate receive protocol processing block. (Step ii).

TCP receive-side processing takes place and the destination part is identified from the packet. If the packet contains valid data for the port then the packet is engaged on the port's data queue (step iii) and that port marked (which may involve the scheduler and the awakening of blocked process) as holding valid data.

The TCP receive processing may require other packets to be transmitted (step iv), for example in the cases that previously transmitted data should be retransmitted or that previously enqueued data (perhaps because the TCP window has opened) can now be transmitted. In this case packets are enqueued with the OS “NDIS” driver for transmission.

In order for an application to retrieve a data buffer it must invoke the OS API (step v), for example by means of a call such as recv( ), select( ) or poll( ). This has the effect of informing the application that data has been received and (in the case of a recv( ) call) copying the data from the kernel buffer to the application's buffer. The copy enables the kernel (OS) to reuse its network buffers, which have special attributes such as being DMA accessible and means that the application does not necessarily have to handle data in units provided by the network, or that the application needs to know a priori the final destination of the data, or that the application must pre-allocate buffers which can then be used for data reception.

It should be noted that on the receive side there are at least two distinct threads of control which interact asynchronously: the up-call from the interrupt and the system call from the application. Many operating systems will also split the up-call to avoid executing too much code at interrupt priority, for example by means of “soft interrupt” or “deferred procedure call” techniques.

The send process behaves similarly except that there is usually one path of execution. The application calls the operating system API (e.g. using a send ( ) call) with data to be transmitted (Step vi). This call copies data into a kernel data buffer and invokes TCP send processing. Here protocol is applied and fully formed TCP/IP packets are enqueued with the interface driver for transmission.

If successful, the system call returns with an indication of the data scheduled (by the hardware) for transmission. However there are a number of circumstances where data does not become enqueued by the network interface device. For example the transport protocol may queue pending acknowledgements or window updates, and the device driver may queue in software pending data transmission requests to the hardware.

A third flow of control through the system is generated by actions which must be performed on the passing of time. One example is the triggering of retransmission algorithms. Generally the operating system provides all OS modules with time and scheduling services (driven by the hardware clock interrupt), which enable the TCP stack to implement timers on a per-connection basis.

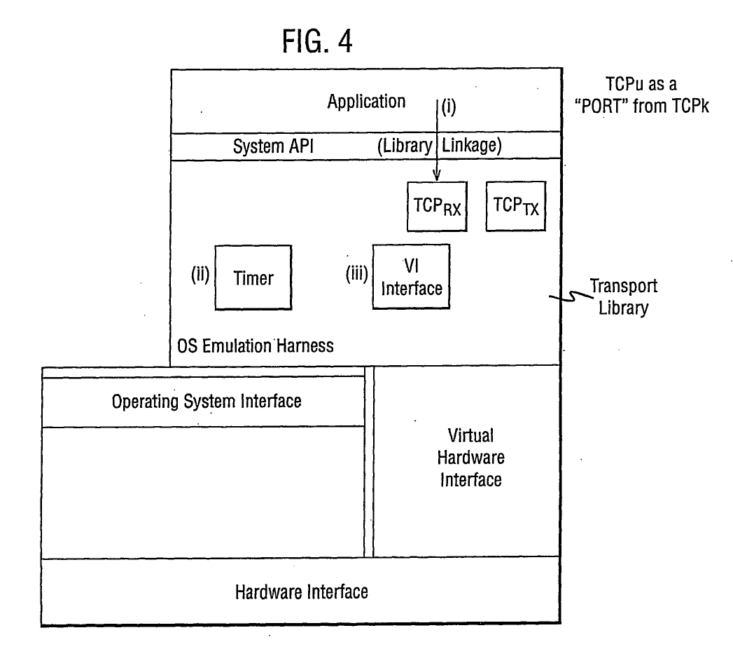

If a standard kernel stack were implemented at user-level then the structure might be generally as shown in FIG. 4. The application is linked with the transport library, rather than directly with the OS interface. The structure is very similar to the kernel stack implementation with services such as timer support provided by user level packages, and the device driver interface replaced with user-level virtual interface module. However in order to provide the model of a asynchronous processing required by the TCP implementation there must be a number of active threads of execution within the transport library:

System API calls provided by the application

Timer generated calls into protocol code

Management of the virtual network interface and resultant upcalls into protocol code. (ii and iii can be combined for some architectures)

However, this arrangement introduces a number of problems: The overheads of context switching between these threads and implementing locking to protect shared-data structures can be significant, costing a significant amount of processing time.

The user level timer code generally operates by using operating system provided timer/time support. Large overheads caused by system calls from the timer module result in the system failing to satisfy the aim of preventing interaction between the operating system and the data path.

There may be a number of independent applications each of which manages a sub-set of the network connection; some via their own transport libraries and some by existing kernel stack transport libraries. The NIC must be able to efficiently parse packets and deliver them to the appropriate virtual interface (or the OS) based on protocol information such as IP port and host address bits.

It is possible for an application to pass control of a particular network connection to another application for example during a forko system call on a Unix operating system. This requires that a completely different transport library instance would be required to access connection state. Worse, a number of applications may share a network connection which would mean transport libraries sharing ownership via (inter process communication) techniques. Existing transports at user level do not attempt to support this.

It is common for transport protocols to mandate that a network connection outlives the application to which it is tethered. For example using the TCP protocol, the transport must endeavour to deliver sent, but unacknowledged data and gracefully close a connection when a sending application exits or crashes. This is not a problem with a kernel stack implementation that is able to provide the “timer” input to the protocol stack no matter what the state (or existence) of the application, but is an issue for a transport library which will disappear (possibly ungracefully) if the application exits, crashes, or stopped in a debugger.

A further issue is that if a network interface device is intended to carry out filtering of packets it is desirable that the means used for filtering are as efficient as possible. One means of filtering packets is by processing the packet headers using a content addressable memory (CAM). Filtering is commonly performed on a number of fields of the header, including source and destination ports and addresses. A CAM could be provided that is wide enough to accommodate, in every row of the CAM, the full width of all the fields against which filtering is to be performed. However, it would be desirable to be able to operate with a narrower CAM. This is particularly significant since CAMs are normally available in standard widths, such as 64 or 128 bits, and the full width of the fields may fall between those widths, which also would require a wider CAM to be used.

It would be desirable to provide a system that at least partially addresses one or more of these problems a to e.

According to the present invention there is provided a network interface device for providing an interface between a host device and a network by receiving packets over the network and passing at least some of those packets to ports of the host device, each packet comprising a control section having one or more fields indicative of the type and data protocol of the packet, a source address field indicative of the source address of the packet, a destination address field indicative of the destination address of the packet, a source port field indicative of the source address of the packet and a destination port field indicative of the destination address of the packet; the network device comprising: a data store for storing specifications for packets that are to be passed to the host device, each specification comprising first, second and third check fields; and a packet selection unit for selecting in accordance with the content of the data store which packets received over the network are to be passed to the host device; the packet selection unit being capable of identifying the protocol of a received packet and operable in at least: a first mode in which for packets of a first protocol and of a type indicative of a request to establish a new connection it passes such packets to the host device only if the data store stores a specification whose first check field matches the destination address of the packet, whose second check field matches a reserved datagram and whose third check field matches the destination port of the packet; and a second mode in which for packets of a second protocol it passes such packets to the host device only if the data store stores a specification whose first check field matches the destination address of the packet, whose second check field matches the destination port of the packet and whose third check field matches the reserved datagram.

Other aspects and preferred features of the present invention are set out in the claims.

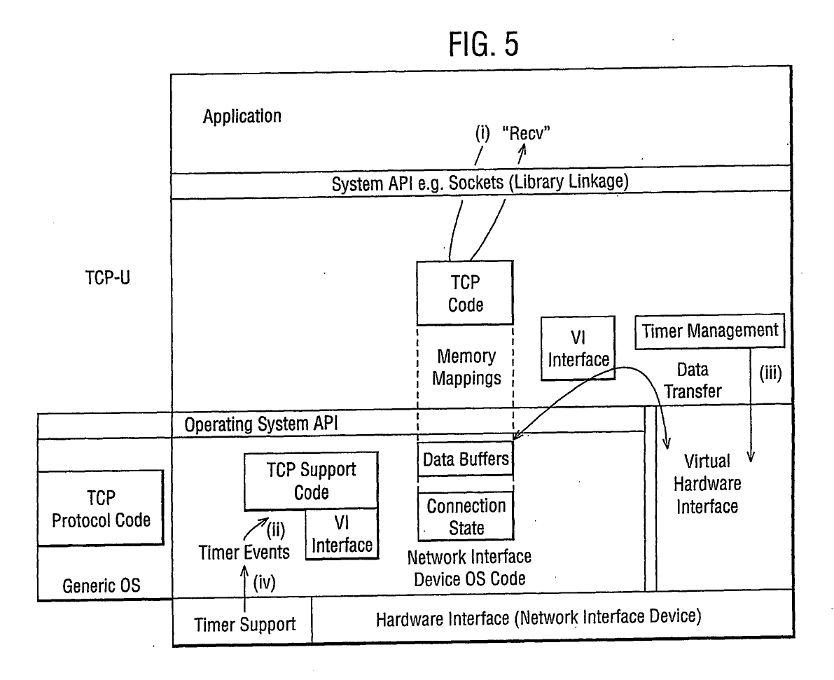

FIG. 5 shows an example of a TCP transport architecture suitable for providing an interface between a network interface device such as device 10 of FIG. 1 and a computer such as computer 1 of FIG. 1. The architecture is not limited to this implementation.

The principal differences between the architecture of the example of FIG. 5 and conventional architectures are as follows.
(i) TCP code which performs protocol processing on behalf of a network connection is located both in the transport library, and in the OS kernel. The fact that this code performs protocol processing is especially significant.
(ii) Connection state and data buffers are held in kernel memory and memory mapped into the transport library's address space.
(iii) Both kernel and transport library code may access the virtual hardware interface for and on behalf of a particular network connection.
(iv) Timers may be managed through the virtual hardware interface, (these correspond to real timers on the network interface device) without requiring system calls to set and clear them. The NIC generates timer events which are received by the network interface device driver and passed up to the TCP support code for the device.

It should be noted that the TCP support code for the network interface device is in addition to the generic OS TCP implementation. This is suitably able to co-exist with the stack of the network interface device.

The effects of this architecture are as follows.

(a) Requirement for Multiple Threads Active in the Transport Library

This requirement is not present for the architecture of FIG. 5 since TCP code can either be executed in the transport library as a result of a system API call (e.g. recv( ) (see step i of FIG. 5) or by the kernel as a result of a timer event (see step ii of FIG. 5). In ether case, the VI (virtual interface) can be managed and both code paths may access connection state or data buffers, whose protection and mutual exclusion may be managed by shared memory locks. As well as allowing the overheads of thread switching at the transport library level to be removed, this feature can prevent the requirement for applications to change their thread and signal-handling assumptions: for example in some situations it can be unacceptable to require a single threaded application to link with a multi-threaded library.

(b) Replacement to Issue System Calls for Timer Management

This requirement is not present for the architecture of FIG. 5 because the network interface device can implement a number of timers which may be allocated to particular virtual interface instances: for example there may be one timer per active TCP transport library. These timers can be made programmable (see step iii of FIG. 5) through a memory mapped VI and result in events (see step iv of FIG. 5) being issued. Because timers can be set and cleared without a system call the overhead for timer management is greatly reduced.

(c) Correct Delivery of Packets to Multiple Transport Libraries

The network interface device can contain or have access to content addressable memory, which can match bits taken from the headers of incoming packets as a parallel hardware match operation. The results of the match can be taken to indicate the destination virtual interface which must be used for delivery, and the hardware can proceed to deliver the packet onto buffers which have been pushed on the VI. One possible arrangement for the matching process is described below. The arrangement described below could be extended to de-multiplex the larger host addresses associated with IPv6, although this would require a wider CAM or multiple CAM lookups per packet than the arrangement as described.

One alternative to using a CAM for this purpose is to use a hash algorithm that allows data from the packets' headers to be processed to determine the virtual interface to be used.

(d) Handover of Connections Between Processes/Applications/Threads

When a network connection is handed over the same system-wide resource handle can be passed between the applications. This could, for example, be a file descriptor. The architecture of the network interface device can attach all state associated with the network connection with that (e.g.) file descriptor and require the transport library to memory map on to this state. Following a handover of a network connection, the new application (whether as an application, thread or process)—even if it is executing within a different address space—is able to memory-map and continue to use the state. Further, by means of the same backing primitive as used between the kernel and transport library any number of applications are able to share use of a network connection with the same semantics as specified by standard system APIs.

(e) Completion of Transport Protocol Operations when the Transport Library is Ether Stopped or Killed or Quit.

This step can be achieved in the architecture of the network interface device because connection state and protocol code can remain kernel resident. The OS kernel code can be informed of the change of state of an application in the same manner as the generic TCP (TCPk) protocol stack. An application which is stopped will then not provide a thread to advance protocol execution, but the protocol will continue via timer events, for example as is known for prior art kernel stack protocols.

There are a number newly emerging protocols such as IETF RDMA and iSCSI. At least some of these protocols were designed to run in an environment where the TCP and other protocol code executes on the network interface device. Facilities will now be described whereby such protocols can execute on the host CPU (i.e. using the processing means of the computer to which a network interface card is connected). Such an implementation is advantageous because it allows a user to take advantage of the price/performance lead of main CPU technology as against co-processors.

Protocols such as RDMA involve the embedding of framing information and cyclic redundancy check (CRC) data within the TCP stream. While framing information is trivial to calculate within protocol libraries, CRC's (in contrast to checksums) are computationally intensive and best done by hardware. To accommodate this, when a TCP stream is carrying an RDMA or similar encapsulation an option in the virtual interface can be is enabled, for example by means of a flag. On detecting this option, the NIC will parse each packet on transmission, recover the RDMA frame, apply the RDMA CRC algorithm and insert the CCRC on the fly during transmission. Analogous procedures can beneficially be used in relation to other protocols, such as iSCSI, that require computationally relatively intensive calculation of error check data.

In line with this system the network interface device can also verify CRCs on received packets using similar logic. This may, for example, be performed in a manner akin to the standard TCP checksum off-load technique.

Protocols such as RDMA also mandate additional operations such as RDMA READ which in conventional implementations require additional intelligence on the network interface device. This type of implementation has led to the general belief that RDMA/TCP should best be implemented by means of a co-processor network interface device. In an architecture of the type described herein, specific hardware filters can be encoded to trap such upper level protocol requests for a particular network connection. In such a circumstance, the NIC can generate an event akin to the timer event in order to request action by software running on the attached computer, as well a delivery data message. By triggering an event in such a way the NIC can achieve the result that either the transport library, or the kernel helper will act on the request immediately. This can avoid the potential problem of kernel extensions not executing until the transport library is scheduled and can be applied to other upper protocols if required.

One advantage that has been promoted for co-processor TCP implementations is the ability to perform zero-copy operations on transmit and receive. In practice, provided there is no context switch or other cache or TLB (transmit look-aside buffer) flushing operations on the receive path (as for the architecture described above) there is almost no overhead for a single-copy on receive since this serves the purpose of loading the processor with received data. When the application subsequently accesses the data it is not impacted by cache misses, which would otherwise be the case for a zero copy interface.

However on transmit, a single copy made by the transport library does invoke additional overhead both in processor cycles and in cache pollution. The architecture described above can allow copy on send operations to be avoided if the following mechanisms are, for example, implemented:
(i) transmitted data can be acknowledged quickly (e.g. in a low-latency environment); alternatively
(ii) where data is almost completely acknowledged before all the data in a transfer is sent (e.g. if bandwidth x delay product is smaller than the message size).

The transport library can simply retain sent buffers until the data from them is acknowledged, and data transmitted without copying. This can also be done when asynchronous networking APIs are used by applications.

Even where data copy is unavoidable, the transport library can use memory copy routines which execute non-temporal stores. These can leave copied data in memory (rather than cache), thus avoiding cache pollution. The data not being in cache would not be expected to affect performance since the next step for transmission will be expected to be DMA of the data by the network interface device, and the performance of this DMA operation is unlikely to be affected by the data being in memory rather than cache.

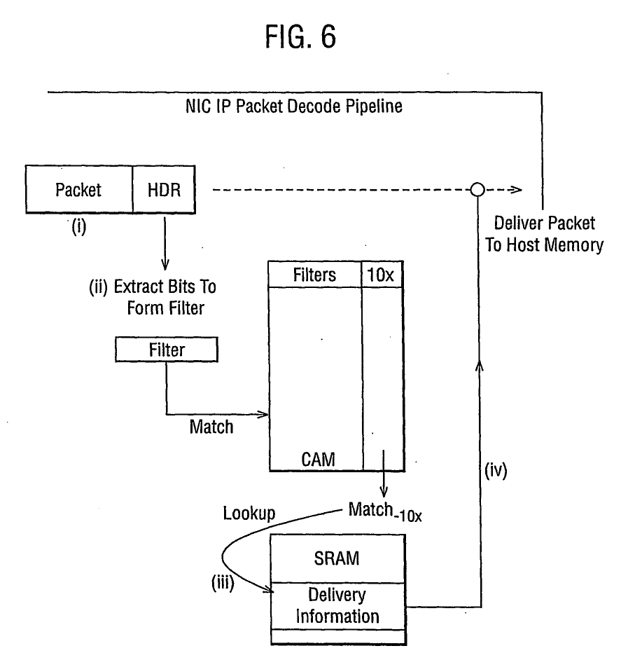

FIG. 6 shows the steps that can be taken by the network interface device described above to filter an incoming TCP packet. At step I the packet is received by the network interface device from the network and enters the receive decode pipeline. At step ii the hardware extracts relevant bits from the packet and forms a filter (which in this example is 32 bits long) which is presented to the CAM. The configuration and number of relevant bits depends on the protocol that is in use; this example relates to TCP/IP and UDP/IP. At step iii, when a CAM match is made it results in an index: MATCH_IDX being returned, which can be used to look up delivery information (e.g. the memory address of the next receive buffer for this connection). At step iv this delivery information is fed back to the packet decode pipeline and enables the packet to be delivered to the appropriate memory location.

The selection of the bits and their use to form the filter will now be described. The logic that determines the configuration of the CAM filter depends on the protocol(s) that is/are to be used. In a practical implementation the CAM could be configured through a virtual interface by means of transport library code, allowing it to be set up dynamically for a particular implementation.

Under the TCP protocol the unique identity of an endpoint would normally require all host and port fields in order for it to be unambiguously specified. This requirement arises because the TCP protocol definition allows: multiple clients to connect to network endpoints with the same destination host and port addresses, a connection to be initiated from either the client or the server, or a server network endpoint to accept connection requests on a singly endpoint and to spawn new network endpoints to handle the data transfer.

The header in such packets is typically 96 bits long. However, constructing a 96-bit filter is inefficient for most commercially available CAMs since they are typically are available with widths of 64 or 128 (rather than 96) bits. The above mechanism enables 64 bit filters to be constructed more efficiently. The length of the CAM may be chosen to suit the application. A convenient size may be 16 kb.

The network interface device can (preferably in hardware) interrupt or buffer the flow of incoming packets in order that it can in effect pause the network header. This allows it to identify relevant bit sequences in incoming packets without affecting the flow of data. For TCP and/or UDP packets the identification of bit sequences may, for example, be implemented using a simple decode pipeline for because of the simple header layout of such packets. This results in a number of fields held in registers.

It is assumed that zero is neither a valid port number nor a valid IP address, and that interfaces in separate processes do not share a local IP address and port pair (except where a socket is shared after a fork( ) command or the equivalent). The latter condition means it is safe to disregard the local IP address when demultiplexing received TCP packets.

For a listening TCP socket only the local IP and port number need be considered, whereas for an established TCP socket remote IP and both port numbers should be considered. The processing performed by the network interface device should therefore (conveniently in hardware) determine whether a received packet is a TCP or a UDP packet, and for TCP packets must inspect the SYN and ACK bits. It can then form a token accordingly, which is looked up in the CAM. The operation of the CAM is illustrated in the following table:

TABLE 1

| | | Bits 0-31 | Bits 32-47 | Bits 48-63 |
|---|---|---|---|---|
| A | TCP SYN = 1 & ACK = 0 | Local (dest) IP | 0 | Dest port |
| B | TCP otherwise | Remote (src) IP | Src port | Dest port |
| C | UDP | Local (dest) IP | Dest port | 0 |

In this table, the first column indicates the type of received packet, and the remaining columns indicate the content of the first 32 bits of the token, the next 16 bits and the final 16 bits respectively. The order of the bits is immaterial provided the same convention is used consistently.

Table 1 illustrates three types of filter arrangement in rows A, B and C. It will be appreciated that the order of the bits is immaterial providing consistency is maintained between the form of data used when the CAM is loaded and when a look-up is performed.

In most cases, when a data channel is configured between the NIC and its host device (for instance data processing equipment to which it is connected) one or more rows of the CAM are loaded with data such that the packets required by that channel will be passed by the NIC on executing the procedures described below. For each row in the CAM the NIC stores, for example in a second CAM, an indication of the identity of the channel to which that row relates. In this way, once an incoming packet has been matched to a particular row of the CAM the NIC can determine by means of a second look-up operation which channel to direct that packet to. When the channel is torn down, the corresponding data is deleted from the CAM(s).

When an incoming packet is received a subset of the data in its header is extracted and ordered by the NIC to form look-up input data to the CAM. The look-up input data is applied to the CAM, which returns the address of any match. Based on whether there is a match, and on the nature of any match, the CAM determines whether to allow the packet to pass to the host, or to drop it. Which data is extracted from the header, and the order in which it is arranged, depends on which filter arrangement is to be used. The filter arrangements of rows A, B and C of table 1 are selected such that for components of a valid packet header ordered according to one of the filter arrangements there can be no match against rows of the cam that relate to another of the filter arrangements.

Multiple procedure modes are available for processing received TCP and UDP packets against the CAM. The selection of a mode for TCP is independent of the selection of a mode for UDP.

The first step in processing a received packet is to determine whether it is a TCP or a UDP packet. TCP packets are processed according to a selected one of the TCP modes. UDP packets are processed according to a selected one of the UDP modes.

TCP Mode 1

TCP mode 1 is as described above. A check is made to determine whether the TCP packet is a SYN packet and not an ACK packet, i.e. whether the SYN bit is set to 1 and the ACK bit is set to 0. If so, a CAM look-up is performed according to filter arrangement A: i.e. a 64-bit string formed of the packet's local (destination) address for bits 0 to 31, zeros for bits 32 to 47 and the local (destination) port for bits 48 to 63 in order is formed and applied to the CAM. If not, a CAM look-up is performed according to filter arrangement B: i.e. a 64-bit string formed of the remote (source) address for bits 0 to 31, the remote (source) port for bits 32 to 47 and the local (destination) port for bits 48 to 63. In each case, if there is a match then the NIC passes the packet to the appropriate channel of the host, and otherwise it drops it or passes it to a default channel of the host whereby it can be handled by software running on the host.

TCP Mode 2

TCP mode 1 has the disadvantage that a row in the CAM is required for each channel. For servers that support connections with very many remote hosts, such as heavily loaded web servers, that can require a very long CAM. TCP mode 2 can be adopted to overcome this.

In TCP mode 2 a CAM look-up is performed according to filter arrangement B for all TCP packets. If there is a match then the NIC passes the packet to the appropriate channel of the host, and otherwise it drops it.

If this mode is being employed there can only be one transport library on the host for each destination address. However, there is no need to configure a row in the CAM for each source address to which there is a connection.

TCP Mode 3

In TCP mode 3 a CAM look-up is performed according to filter arrangement B for all TCP packets. If there is a match then the NIC passes the packet to the appropriate channel of the host. Otherwise the NIC performs a CAM look-up according to filter arrangement A. If there is then a match then the NIC passes the packet to the appropriate channel of the host, and otherwise it drops it. The order of these filtering steps could be reversed, but that is not preferred.

This mode has the advantage that multiple transport libraries can be supported whilst avoiding a requirement for a single CAM entry for every connection.

UDP Mode 1

In UDP mode 1 a CAM look-up is performed according to filter arrangement C for all UDP packets. If there is a match then the NIC passes the packet to the appropriate channel of the host, and otherwise it drops it.

UDP Mode 2

UDP mode 1 has the disadvantage that it does not support connected UDP at the NIC level, which is desirable to simplify the processing required on the host. In connected UDP the host can specify for a channel a remote host address:port pairing as being the only one from which it is to receive UDP packets on that channel, and UDP packets from that remote host are automatically routed to that channel.

UDP mode 2 supports connected UDP. Additional filter arrangements D1 and D2 are provided, as illustrated in table 2. These must be both be configured for any connected UDP connection, and set up in consecutive rows of the CAM. For other UDP connections these rows will not form a match since bits 0 to 31 are set to zero, unlike any of the other filter arrangements.

TABLE 2

| | Bits 0-31 | Bits 32-47 | Bits 48-63 |
|---|---|---|---|
| D1 | 0 | Remote (src) IP | Src port |
| D2 | 0 | Local (dest) IP | Dest port |

In UDP mode 2 a CAM look-up is performed according to filter arrangement D1 for all UDP packets. If there is a match then the NIC stores the address of the row where a match was made and performs a CAM look-up according to filter arrangement D2. If there is a match on the row of the CAM immediately after that on which the match occurred on the first look-up then the NIC passes the packet to the appropriate channel of the host. Otherwise it drops the packet. If there is no match on the first look-up then a CAM look-up is performed according to filter arrangement C. If there is a match then the NIC passes the packet to the appropriate channel of the host, and otherwise it drops it.

Since some of the modes require two CAM look-ups for each packet, the CAM should be capable of supporting look-ups at at least twice the incoming data rate of the NIC if all the above modes are to be supported. Alternatives to using a CAM include hashing techniques: for instance RAM-based hashing, to perform each lookup step.

The following table gives examples of how the data may be formed:

TABLE 3

| Packet type | Bits 0-31 | Bits 32-47 | Bits 48-63 |
|---|---|---|---|
| 1. TCP listen | 192.168.123.135 | 0 | 80 |
| 2. TCP established | 66.35.250.150 | 33028 | 80 |
| 3. TCP established | 66.35.250.150 | 23 | 28407 |
| 4. UDP | 192.168.123.135 | 123 | 0 |

In the examples number 1 illustrates the situation for a local web server listening on 192.168.123.135:80; number 2 illustrates the situation for a connection accepted by that server from 66.35.250.150:33028; number 3 illustrates a telnet connection to 66.35.250.150, initiated locally; and number 4 illustrates the situation for an application receiving UDP packets on port 123.

By separating out the situation where TCP SYN=1 & ACK=0, as in the first row of table 1, it can be ensured that such entries match TCP connection request messages (destined for sockets in the LISTEN state), but do not match connection replies (which are destined for sockets in the SYN_SENT state).

Other combinations of zero fields could be used to demultiplex on other fields. For example, demultiplexing could be performed on the ETHER_TYPE field of the Ethernet header.

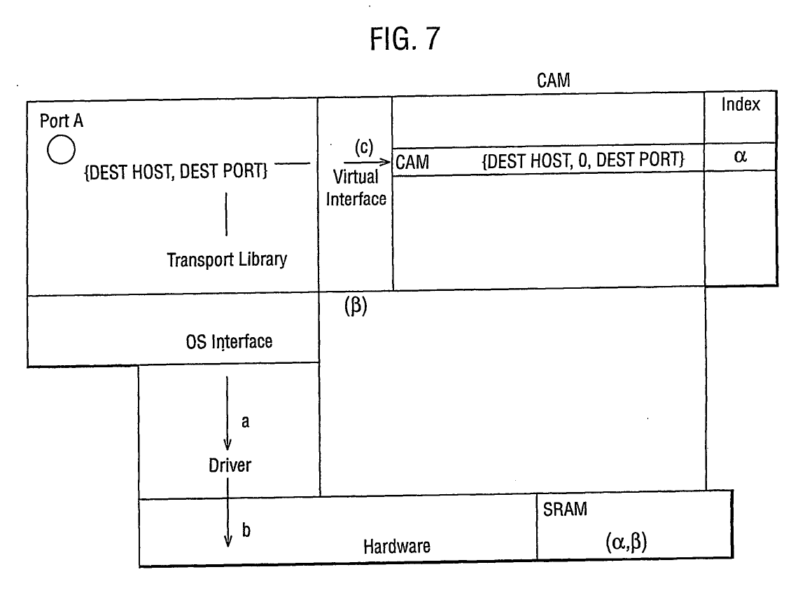

The above procedure is illustrated by way of example with respect to the server (PASSIVE) connection, the contents of the CAM (programmed by the server transport library) and the filters presented to the CAM by the NIC on each packet, as illustrated in FIG. 7. This involves the following steps:
(a) The transport library allocates a CAM entry via the driver.
(b) The driver programs the hardware through its protected control interface to map the allocated CAM into the address space allocated to the transport library's virtual interface.
(c) The transport library programs the CAM entry via its virtual interface. Where an application is deemed to have insufficient access rights to receive a programmable CAM entry, it can instead be permitted to do so via OS calls.

(ii) A TCP/IP connect packet arrives. Because the SYN bit in the packet header is set to one and the ACK bit in the packet header is set to zero, the network interface device can construct the filter:
{dest host, 0, dest port}
from the bits in the packet header and presents it to the CAM. This causes a match to occur with CAM index X. The network interface device can then look up and in the SRAM to find the base address of the virtual interface: β. The NIC can then deliver the packet to virtual interface β.

As a result of the connect packet, the server application may create another network endpoint to handle the network connection. This endpoint may be within its own or another application context and so may be managed by another transport library. In either case, a network connection can be created which joins:
{dest host, port}
to
{source host, port}
the server programs a new CAM entry with:
{source host, source port, dest port}

(iii) When a packet arrives for the new network connection, it will have its SYN bit set to zero. This causes the NIC to construct a filter:
{source, host source port, dest port}
which when presented to the CAM causes a match index θ to be produced which matches virtual interface a in the SRAM. It should be noted that σ may be the same as β if the network connection is managed by the same transport library as the server endpoint.

This encoding can similarly be employed for active (client) connections initiated by the host and for all models of communication specified in the TCP and UDP protocol specifications. One notable benefit of the encoding scheme is that it enables the hardware to determine the address of the virtual interface using only one CAM lookup.

The network interface device preferably also supports a mode of operation in which it simply de-multiplexes packets onto transport libraries, rather than on to network endpoints. This may be beneficial where the device is handling communications between a network and a server which is required to service large numbers (e.g. millions) of connections with the network simultaneously. Examples of this may be high-capacity web server nodes. Two options are available. One option is to store only filters of the form:
{dest host, dest port}
in the CAM. Another option is to employ a ternary CAM which can mask using “don't care” bits. It should be noted that if both modes of operation were to be enabled simultaneously then efficiency may be reduced because two CAM lookups might be required due to the necessity to construct different filters when the SYN bit is set to zero in a received packet. This requirement would be avoided if only one mode were enabled at a time.

In this way TCP/IP and UDP/IP packets can both be matched using 64 bits of CAM: as opposed to the 128 bits that would be required if a standard sized CAM using bit-by-bit matching over the whole header were to be used.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

While various embodiments of the invention have been described, it will be apparent to those of ordinary skill in the art that many more embodiments and implementations are possible that are within the scope of this invention. In addition, the various features, elements, and embodiments described herein may be claimed or combined in any combination or arrangement.

1. A network interface device for providing an interface between a host device and a network by receiving packets over the network and passing at least some of those packets to ports of the host device, each packet comprising a control section having one or more fields indicative of the type and data protocol of the packet, a source address field indicative of the source address of the packet, a destination address field indicative of the destination address of the packet, a source port field indicative of the source address of the packet and a destination port field indicative of the destination address of the packet; the network device comprising:
a data store for storing specifications for packets that are to be passed to the host device, each specification comprising first, second and third check fields; and
a packet selection unit for selecting in accordance with the content of the data store which packets received over the network are to be passed to the host device; the packet selection unit being capable of identifying the protocol of a received packet and operable in at least:
a first mode in which for packets of a first protocol and of a type indicative of a request to establish a new connection it passes such packets to the host device only if the data store stores a specification whose first check field matches the destination address of the packet, whose second check field matches a reserved datagram and whose third check field matches the destination port of the packet; and
a second mode in which for packets of a second protocol it passes such packets to the host device only if the data store stores a specification whose first check field matches the destination address of the packet, whose second check field matches the destination port of the packet and whose third check field matches the reserved datagram.

2. A network interface device as claimed in claim 1, wherein in the first mode the packet selection unit is operable to, for packets of the first protocol that are not indicative of a request to establish a new connection, pass such packets to the host device only if the data store stores a specification whose first check field matches the source address of the packet, whose second check field matches the source port of the packet and whose third check field matches the destination port of the packet.

3. A network interface device as claimed in claim 1, wherein the packet selection unit is operable in a third mode in which for all packets of the first protocol it passes such packets to the host device only if the data store stores a specification whose first check field matches the source address of the packet, whose second check field matches the source port of the packet and whose third check field matches the destination port of the packet.

4. A network interface device as claimed in claim 3, wherein the packet selection unit is operable in a fourth mode in which for all packets of the first protocol it passes such packets to the host device only if the data store stores a specification whose first check field matches the destination address of the packet, whose second check field matches the reserved datagram and whose third check field matches the destination port of the packet or if the data store stores a specification whose first check field matches the source address of the packet, whose second check field matches the source port of the packet and whose third check field matches the destination port of the packet.

5. A network interface device as claimed in claim 4, wherein the packet selection unit is selectively operable in one of the first mode and whichever of the third and fourth modes it supports.

6. A network interface device as claimed claim 4, wherein the packet selection unit is operable in a fifth mode in which for all packets of the second protocol it passes such packets to the host device only if the data store stores a first specification whose first check field matches the reserved datagram, one of whose second and third check fields matches the source address of the packet and the other of whose second and third check fields matches the source port of the packet and if the data store stores a second specification in a manner related by a predetermined relationship to the first specification whose first check field matches the reserved datagram, the said one of whose second and third check fields matches the source port of the packet and the said other of whose second and third check fields matches the destination port of the packet.

7. A network interface device as claimed in claim 6, wherein the said predetermined relationship is that the second specification is stored in the data store at a predetermined spacing from the first specification.

8. A network interface device as claimed in claim 6, wherein the packet selection unit is selectively operable in one of the second and fifth modes.

9. A network interface device as claimed in claim 1, wherein all bits of the predetermined datagram are zero.

10. A network interface device as claimed in claim 1, wherein the first protocol is the TCP protocol.

11. A network interface as claimed in claim 10, wherein the type indicative of a request to establish a new connection is that for which the SYN bit equals 1 and the ACK bit equals 0.

12. A network interface as claimed in claim 1, wherein the length of the first check field is 32 bits.

13. A network interface as claimed in claim 1, wherein the length of the second check field is 16 bits.

14. A network interface as claimed in claim 1, wherein the length of the third check field is 16 bits.

15. A network interface as claimed in claim 1, wherein the data store is a content addressable memory.

16. A network interface as claimed in claim 15, wherein the width of the content addressable memory is 64 bits.
